(19) United States
(12) Patent Application Publication
(10) Pub. No.: US 2012/0268709 A1
(43) Pub. Date: Oct. 25, 2012

(54) TUNABLE OPTICAL FILTERS WITH LIQUID CRYSTAL RESONATORS

(76) Inventors: Aaron J. Zilkie, Painted Post, NY (US); Atul Pradhan, Pittsford, NY (US)

(21) Appl. No.: 13/091,103

(22) Filed: Apr. 20, 2011

(51) Int. Cl. G02F 1/13

(52) U.S. Cl. 349/198

(57) ABSTRACT

A voltage-tuned optical filter that is low cost and simple to fabricate uses cascaded etalon modules, each module comprising a liquid crystal etalon, such as a Fabry-Perot etalon, having a relatively small Free Spectral Range (FSR). At least two of the modules are provided with a voltage control to enable Vernier tuning control. For a given overall scan, the voltage-tuned optical filter may operate with reduced voltage ranges for each liquid crystal etalon.

### BACKGROUND

Tunable optical filters are devices for optical frequency selection. They are used in a wide range of applications, such as selecting laser cavity modes in tunable lasers, creating narrow-band tunable light sources, adding or dropping optical signals of different frequencies from a spectrally multiplexed beam, or making sweeping spectrometers.

A known type of tunable filter found in industry is a tunable planar-lightwave-circuit (PLC) ring resonator filter. In the ring-resonator architecture the resonance can be tuned by temperature, or by changing the material above the ring that is seen by the evanescent optical field. However, this architecture suffers from the primary disadvantage that PLC devices are costly to fabricate.

A known architecture for a tunable optical filter, attractive because of its low cost, is a tunable Fabry-Perot (FP) etalon. In the tunable FP etalon architecture, the resonance frequency of the device is tuned by changing the cavity optical path length, either by changing the refractive index of the medium in the etalon cavity, or by changing the length of the etalon cavity. Common low-cost implementations of an optical-fiber-based tunable Fabry-Perot etalon are: i) a free-space dielectric slab in which the resonance of the dielectric slab is tuned by temperature, ii) a gap between two cleaved fiber ends, with the gap distance tunable by the piezo-electric effect, and iii) a liquid-crystal slab in which the index of the liquid crystal is changed by an applied variable electric voltage.

For many widely used applications a large free-spectral-range (FSR) is required. An important application, a C-band scanning spectrometer, requires an FSR which is greater than the C-band (>5 THz), so that at all tuning points it only passes one segment of the C-band spectrum. Recent industry mass-deployment of tunable dispersion compensators based on precisely-temperature-tuned dielectric slab etalons has lowered the cost of fiber lens collimators, and the cost of packaging of fiber/dielectric-slab etalon devices. Consequently, tunable filter implementations identified as i) above have become cost effective for some applications. However, a drawback of temperature-tuned dielectric slab devices is the large temperature range required to sweep the filter over the entire frequency band of interest, for example, 5 THz to sweep the C-band as mentioned above. For temperature tuned dielectric slab devices, silicon is the industry-standard substrate material. Typically, temperature ranges of >300° C. are required to tune a silicon slab filter over 5 THz. The structure also requires a stack of 10 to 20 thin layers of materials with differing refractive indicies. To avoid structural degradation these layers require thermal expansion coefficients that precisely match that of the silicon substrate. For applications such as optical channel monitoring (OCM) in multiplexed optical communications networks, one sweep every few seconds over a device lifetime of 15-20 years may be used. Complex and expensive fabrication processes are required to construct and package such a structure so that it does not exhibit performance degradation or failure with such stressful temperature cycling. Additionally, fabrication is complicated by the requirement that the thickness of the slab must be large (e.g., ˜10 mm) for an FSR of 5 THz.

Implementations of tunable filters identified as category ii) above have the disadvantage that the piezoelectric effect suffers from hysteresis, sticking, and unrepeatability over life.

Conventional implementations of tunable optical filters in category (iii) above present difficult challenges in manufacture, involving, for example, engineering the parallelism and reflectivity of the reflective surfaces in the presence of coated dielectric electrodes. Again, this is due in part to the need to tune the liquid crystal element over a very large range to accommodate all wavelengths in the spectrum being processed. However, category (iii) devices offer the important advantage of low power and very fast tuning since the tuning mechanism is electro-optic. Overcoming that limitation would make category (iii) implementations very competitive, and possibly the dominant approach in the industry.

### SUMMARY

One or more embodiments of the present invention provide a voltage-tuned optical filter having cascaded etalon modules, each module comprising a liquid crystal etalon, such as a Fabry-Perot etalon, having a relatively small Free Spectral Range (FSR). At least two of the modules are provided with a voltage control to enable Vernier tuning control. For a given overall scan, the voltage-tuned optical filter may operate with reduced voltage ranges for each liquid crystal etalon.

An embodiment of the present invention provides a method for tuning an optical filter having at least two voltage controlled Fabry-Perot liquid crystal etalon modules N1 and N2, wherein the module N1 has a Free Spectral Range (FSR) of X and module N2 has a FSR of X+/−0.05X to 0.4X. The method includes the step of simultaneously changing the voltage of the N1 and N2 modules over a range of V1 to V2.

An optical filter according to an embodiment of the present invention includes a liquid crystal Fabry-Perot etalon module N1, the module N1 having a Free Spectral Range (FSR) of X, an N1 voltage control for controlling the voltage of the module N1, a liquid crystal Fabry-Perot etalon module N2 spaced from and optically aligned with the module N1, the module N2 having a FSR of X+/−0.05X to 0.4X, and an N2 voltage control for controlling the voltage of the module N2.

An optical filter according to another embodiment of the present invention includes a plurality of liquid crystal etalon modules connected in a cascaded manner, wherein a Free Spectral Range (FSR) of the optical filter is X and the FSR of each of the etalon modules is equal to or less than 0.5*X.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating the operation of an LCTE element useful in one or more embodiments of the present invention.

FIG. 2 is an elevation view showing the structure of an LCTE element that is used in one or more embodiments of the present invention.

FIG. 3 is a schematic representation of a two-module LCTF with individual voltage controls.

FIG. 4 is a schematic representation of a three-module LCTF with individual voltage controls.

FIG. 5 is a plot showing simulated filter transmission in dB for the LCTF described in connection with FIG. 3.

FIG. 6 is a plot showing simulated filter transmission in dB for another LCTF embodiment similar to that described in connection with FIG. 3.

FIG. 7 is a plot of a typical frequency scan for an LCTF with two LCTEs.

FIG. 8 is a plot showing the change in FSR of the two etalons during the frequency scan of FIG. 7.

FIG. 9 is a plot of a frequency scan using two LCTEs and three cycles.

FIG. 10 is a plot of the voltage difference between the two etalons during the frequency scan of FIG. 9.

FIG. 11 is a plot of the voltages applied to the two etalons during a nine cycle frequency scan.

FIG. 12 is a plot of the voltage difference between the two etalons during the frequency scan of FIG. 11.

FIG. 13 is a plot showing the change in FSR of the two etalons during the frequency scan of FIG. 11.

FIG. 14 shows an alternative voltage cycle pattern for the frequency scan.

For clarity, identical reference numbers have been used, where applicable, to designate identical elements that are common between figures. It is contemplated that features of one embodiment may be incorporated in other embodiments without further recitation.

### DETAILED DESCRIPTION

In one embodiment of the present invention, the LCTEs that are employed are Fabry-Pérot etalons. A Fabry-Pérot etalon is typically made of a transparent plate with two reflecting surfaces. As known, the transmission spectrum of a Fabry-Pérot etalon as a function of wavelength exhibits peaks of large transmission corresponding to resonances of the etalon. In another embodiment of the present invention, the LCTE is composed of a pair of transparent plates with a gap in between, with any pair of the plate surfaces forming two reflecting surfaces.

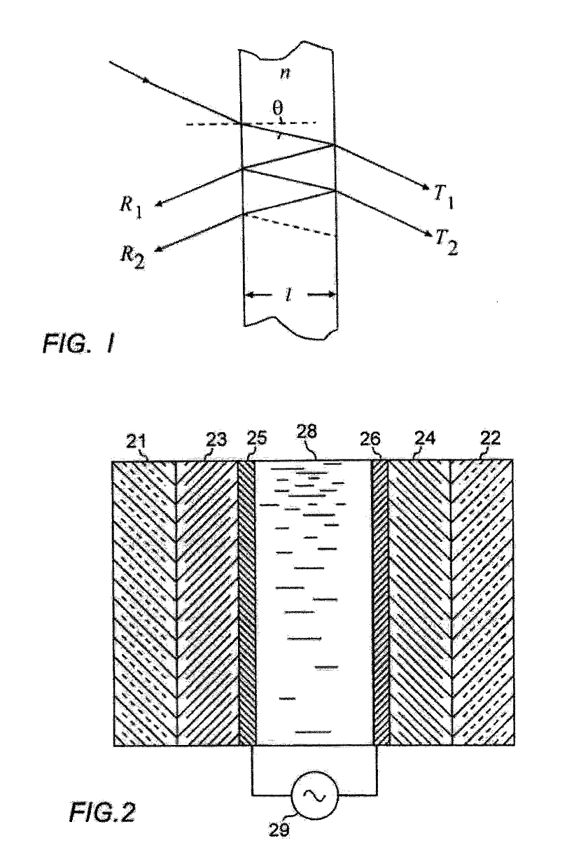

Referring to FIG. 1, which illustrates the operation of an LCTE element useful in one or more embodiments of the present invention, light enters the etalon and undergoes multiple internal reflections. The varying transmission function is caused by interference between the multiple reflections of light between the two reflecting surfaces. Constructive interference occurs if the transmitted beams are in phase, and this corresponds to a high-transmission peak of the etalon. If the transmitted beams are out-of-phase, destructive interference occurs and this corresponds to a transmission minimum. Whether the multiply-reflected beams are in-phase or not depends on the wavelength (λ) of the light, the angle the light travels through the etalon (θ), the thickness of the etalon (l) and the refractive index of the material between the reflecting surfaces (n).

Maximum transmission (Tₑ=1) occurs when the difference in optical path length between each transmitted beam (2nl cos θ) is an integer multiple of the wavelength. In the absence of absorption, the reflectivity of the etalon Rₑ is the complement of the transmission, such that Tₑ+Rₑ=1, and this occurs when the path-length difference is equal to half an odd multiple of the wavelength.

The finesse of the device can be tuned by varying the reflectivity of the surface(s) of the etalon. The finesse of the etalon is related to the etalon reflectivities by:

$$F = \frac{{π ( {R}_{1} {R}_{2} )}^{1 / 4}}{1 - {( {R}_{1} {R}_{2} )}^{1 / 2}}$$

where F is the finesse, R₁, R₂ are the reflectivity of facet 1 and facet 2 of the etalon. The wavelength separation between adjacent transmission peaks is the free spectral range (FSR) of the etalon, Δλ, and is given by:

Δλ=λ₀²/(2nl cos θ)

where λ₀ is the central vacuum wavelength of the nearest transmission peak. The FSR is related to the full-width half-maximum by the finesse of the etalon. Etalons with high finesse show sharper transmission peaks with lower minimum transmission coefficients.

The functional center of a tunable etalon is a medium in which the refractive index can be conveniently varied over a significant range. One or more embodiments of the present invention rely on a liquid crystal medium to provide that function. The container for the liquid crystal medium includes two parallel transparent plates. The refractive index of the liquid crystal medium is varied by applying a variable voltage between thin film electrodes on the transparent plates. The resonant cavity includes means for reflecting light back and forth through the liquid crystal medium.

FIG. 2 is an elevation view showing the structure of an LCTE, in particular a Fabry-Perot etalon, that is used in one or more embodiments of the present invention. The parallel glass plates are shown at 21, 22. The reflecting films are shown at 23, 24, and the conductive thin films are shown at 25, 26. The liquid crystal medium is shown at 28, and the AC drive voltage at 29. The reflecting films may be of any suitable reflecting material that is partially transparent to the light through the etalon as shown. The conductive films 25, 26 are also transparent. A suitable choice for the material of these films is indium tin oxide. The liquid crystal may be a known nematic liquid crystal. Other suitable liquid crystal materials may be substituted.

The structure of the LCTE shown in FIG. 2 is but one example of many etalon designs based on liquid crystal materials as the electro-optic medium. More details of this particular structure may be found in U.S. Pat. No. 5,113,275, issued May 12, 1992. Examples of other etalon devices suitable for use in one or more embodiments of the present invention may be found in U.S. Pat. Nos. 7,298,428; 6,757,046; 6,842,217; 6,954,253; and 7,035,484. As shown in some examples in these references the liquid crystal etalons may be provided with anti-reflection coatings suitably placed to reduce losses by reflection. The placement of the layers shown in FIG. 2 may be varied as shown in U.S. Pat. No. 7,298,428. All of the patents referenced above are incorporated by reference herein in their entirety.

Liquid crystal etalons may be used as tunable optical filters in a variety of optical beam processing applications. By varying the refractive index of the liquid crystal medium the wavelength that is resonant in the Fabry-Perot cavity will change accordingly. As mentioned earlier, one application for tunable optical filters is C-band scanning spectrometers. In this detailed description that application will be the focus. However, it should be understood that it is one example, and other applications and apparatus may advantageously employ the invention. C-band scanning sprectrometers are used for monitoring the channels of Wavelength Division Multiplexed (WDM) signals to detect individual channel degradation. This requires an FSR which is greater than the C-band (>5 THz), so that at all tuning points it only passes one segment of the C-band spectrum. It also requires that the tunable optical filter be tuned over the entire range, i.e., that the voltage of the device be varied over the entire operating range. However, this imposes unnecessary constraints on the device.

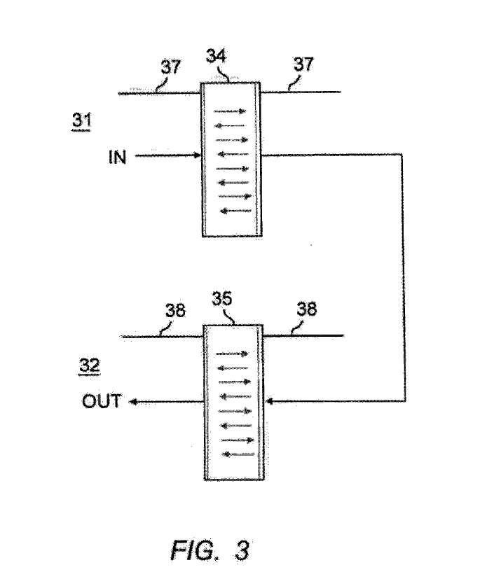

According to one or more embodiments of the invention, a cascade of at least two liquid crystal etalon modules are arranged in the path of the optical beam being processed. This is shown in FIG. 3 where two liquid crystal tunable etalons (LCTEs) are used, i.e., where N=2. Each module, 31, 32, contains a liquid crystal tunable etalon 34 (N1), and 35 (N2), and an associated voltage control unit represented by the electrical leads 37, 38. The arrows represent the direction of the optical beam through the device. In some embodiments of the invention, a Vernier effect of the overall liquid crystal tunable filter (LCTF) results from cascading multiple LCTEs which have FSRs with a fractional portion of the FSR required for an equivalent tunable filter that uses only a single etalon. The fractional portion may be 0.5 or less, preferably 0.33 or less. This allows each filter etalon component to have a lower finesse than would be required for a filter with the same FWHM composing of only a single etalon by itself, and also to be tuned over a voltage range that is smaller than that required for a single etalon by itself. Thus narrower filter BWs can be achieved using LCTF etalons with more relaxed manufacturing tolerances, and the voltage tuning ranges are less compared to what is required for conventional liquid crystal etalon filters, producing a LCTF with fine tuning capability that is easier to manufacture. In this category of LCTFs, the etalons in the filter modules are designed with a FSR of less than 3 GHz, preferably less than 2 GHz, and the voltage range for tuning each LCTE of the LCTF is less than 2 V. An important feature is that each etalon, N1 and N2, in the filter has an FSR that is slightly offset (by a factor of roughly 10%) with respect to the FSR of the other etalons in the cascade. The following are examples for the LCTF shown in FIG. 2.

In Example 1, N=2 etalons, FSR_{N1}=1.81 THz, and FSR_{N2}=2.0 THz. The reflectance of the facets of the etalons in this example is 97%. The finesse of the LCTEs is 100 and the overall finesse of the LCTF is 150. The Full Width at Half Maximum (FWHM) of this example is 18 GHz for the LCTEs and 12 GHz for the LCTF. Adjacent Channel Rejection (ACR) for neighboring 100 GHz WDM channels is >25 dB. In the LCTF of this example the FSR of one of the LCTEs is 9.5% smaller than the FSR of another LCTE.

In Example 2, N=2 etalons, FSR_{N1}=572 GHz, and FSR_{N2}=650 GHz. The reflectance of the facets of the etalons in this example is 97%. The finesse of the LCTEs N1 and N2 is 100 and the overall finesse of the LCTF is 167. The Full Width at Half Maximum (FWHM) of this example is 6 GHz for the LCTEs and 3.6 GHz for the LCTF. Adjacent Channel Rejection (ACR) for neighboring 100 GHz WDM channels is >25 dB. In the LCTF of this example the FSR of one of the LCTEs is 12% smaller than the FSR of another LCTE.

It should be emphasized that the use of two cascaded LCTEs in the manner described doubles the ACR of the overall LCTF and narrows, by nearly half, the FWHM. Further enhancements may be expected where N is greater than 2.

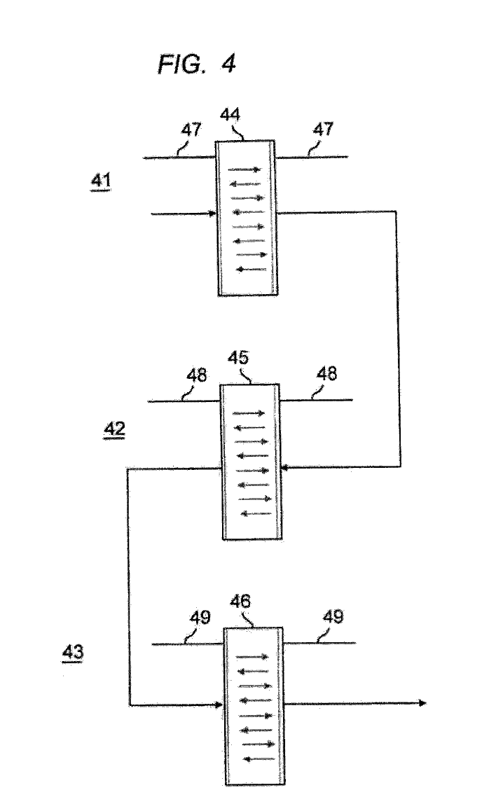

FIG. 4 shows an LCTF device with three stages 41, 42, 43 (N=3). The three stages are optically coupled serially as indicated in the figure. Each of the three stages comprises an etalon 44, 45, 46, and each is provided with an individual voltage control represented by the electrical leads 47, 48, 49. It should be evident that the LCTF may comprise any number of LCTEs by extension from Examples 1 and 2.

In one embodiment, a range recommended for the FSRs of the LCTEs in the cascade relative to the total required FSR of the overall filter is 0.8% to 50%, i.e., if the required FSR of the total LCTF has a value X, the individual LCTEs should have an FSR value of 0.008X to 0.4X. Also the FSRs of the individual LCTEs are recommended to differ by approximately 10% relative to each other, to produce the Vernier effect.

As described earlier, the main resonance frequency of the LCTF is voltage sensitive and the LCTF is tuned by changing the voltage of the N modules of the LCTF. A feature of the LCTF of the invention is that the voltages of the N modules may be independently controlled and independently changed.

The voltages are swept over a range corresponding to the frequency band of interest. In the embodiments shown here that band is approximately 191.5 THz to 196.5 THz. Other bands may be chosen.

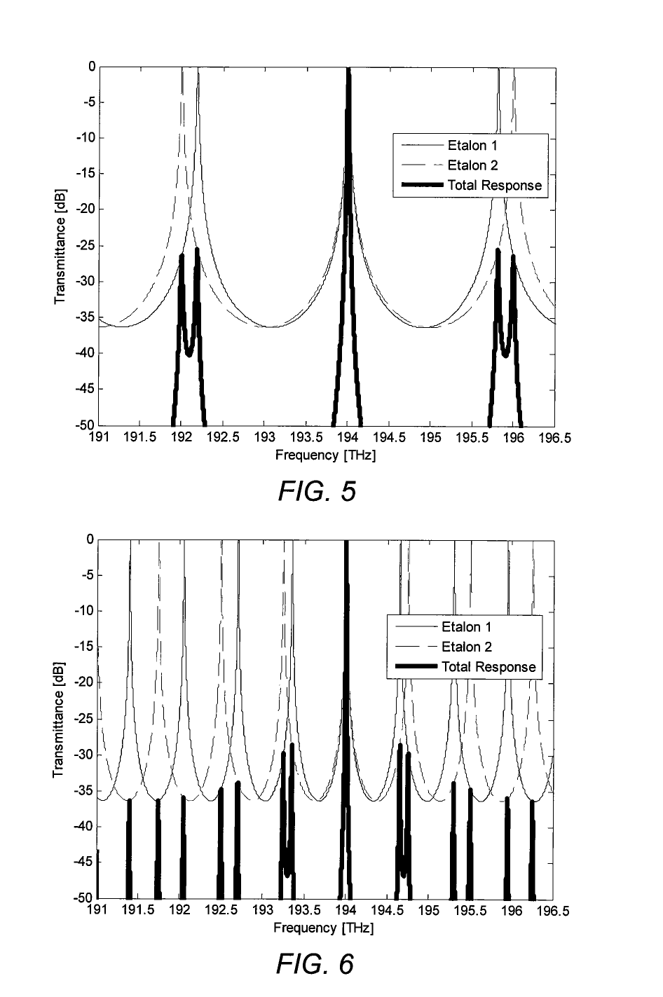

Simulated filter transmittances for the LCTFs described in Examples 1 and 2 above are shown in FIGS. 5 and 6. FIG. 5 shows transmittance over the frequency range 191.5 THz to 196.5 THz of interest, for each of the two LCTEs in Example 1 (designated N1 and N2), and the overall transmittance of the cascaded modules.

FIG. 6 shows transmittance over the frequency range 191.5 THz to 196.5 THz of interest, for each of the two LCTEs in Example 2 (designated N1 and N2), and the overall transmittance of the cascaded modules.

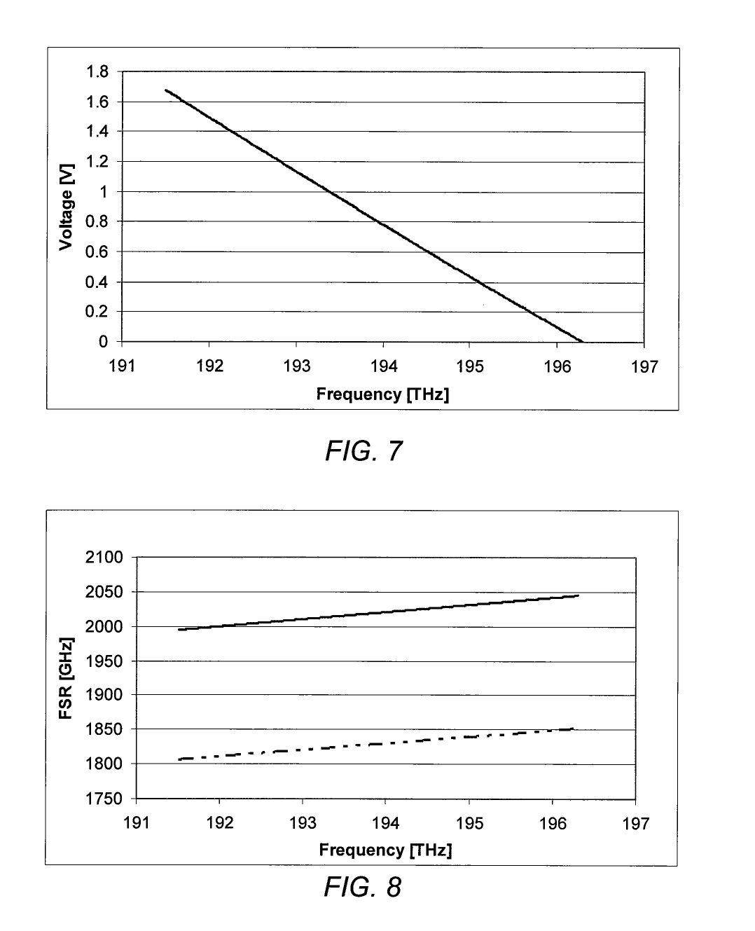

According to one embodiment of the invention the voltages for two or more modules are swept using the same voltage for each module. An example of this embodiment is represented by FIG. 7, where a voltage sweep of two modules, N1 and N2, is shown. The two modules are swept together with the same voltage over the same voltage range. The sweep for both modules is shown as a single line in FIG. 7.

The feature that is common to all of the embodiments of the invention is that the FSR values of the cascaded etalons are slightly different. This is illustrated in FIG. 8 for the embodiment of FIG. 7, and Example 1. The figure shows the FSR in GHz vs. Frequency for N1 (dashed line) and N2 (solid line).

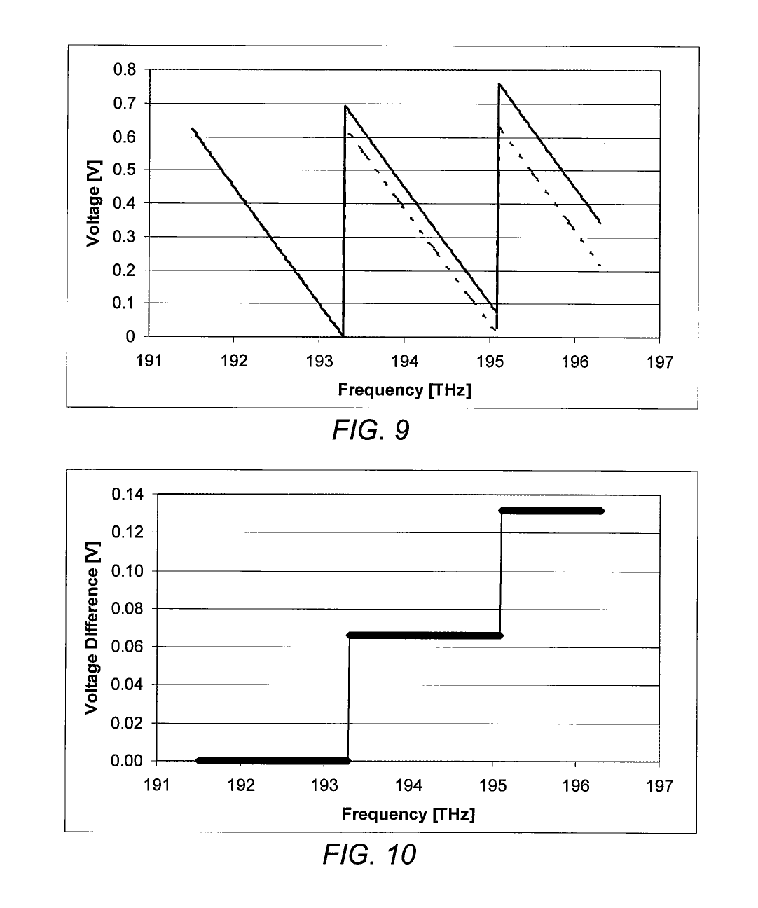

According to another aspect of the invention, the voltage of the N modules is cycled several or many times over a relatively small voltage range to produce a scan of the entire frequency band. This is illustrated in FIG. 9 where the number of cycles, C, is three (C=3). The plot is voltage vs peak frequency. The voltage for each LCTE in the first cycle shown, i.e., between 191.4 THz and 193. 6 THz, is the same. The voltage on each LCTE during the second and third cycles is different as shown. The voltage for N1 is lower in each case than the voltage on N2.

The voltage values shown may be construed as representing deltas from a base voltage. In FIG. 9 the base voltage is 0. The base voltage may vary over a range, e.g., 0-4 volts.

It will be recognized that the voltage range of each cycle in the embodiment represented by FIG. 9 is smaller than the overall range in FIG. 7. Typically the smaller range will represent a fraction 1/C of the overall range, and will provide advantages in some applications.

A cycle, C, is defined as a change in voltage from V1 to V2. At any given time during a scan the voltage of etalon N1 is defined as V_{N1} and the voltage of etalon N2 is V_{N2}. Etalon N1 is cycled between V1_{N1} and V2_{N1}. The range for that cycle is ΔV_{N1}. Etalon N2 is cycled between V1_{N2} and V2_{N2}. The range for that cycle is ΔV_{N2}.

Close inspection of the full cycles in FIG. 9 reveals that etalon N1 is cycled between the same two voltages, V1_{N1} and V2_{N1}, over a range of 0.63 volts. However, etalon N2 is cycled over the same voltage range, 0.63 degrees C., but the voltages V1_{N2} and V2_{N2} change stepwise from cycle to cycle during the scan. It will also be understood that the voltage difference between etalon 1, V_{N1}, and etalon 2, V_{N2}, is fixed during each cycle, and the ratio ΔV_{N2}/ΔV_{N1} is fixed from cycle to cycle. However, the difference between V1 and V2 changes from cycle to cycle. More specifically, the ratio of V1_{N2}/V1_{N1} and the ratio of V2_{N2}/V2_{N1} changes from cycle to cycle. The change may be an increase or decrease but is cumulative over the scan as shown. This is a feature of this embodiment of the invention, and is illustrated in FIG. 10. This figure shows three cycles, and the voltage difference increment between N1 and N2 during each cycle. The voltage difference increment from cycle to cycle in this embodiment is 0.063 volts, i.e., in general terms, less than 0.1 volts.

The voltage difference increment between cycles may vary substantially depending on the number of cycles used, which in turn depends on the application and the precision of the scan. Typically the voltage difference increment from cycle to cycle in a stepped or other cyclic pattern in likely commercial applications will be less than 1.0 volt.

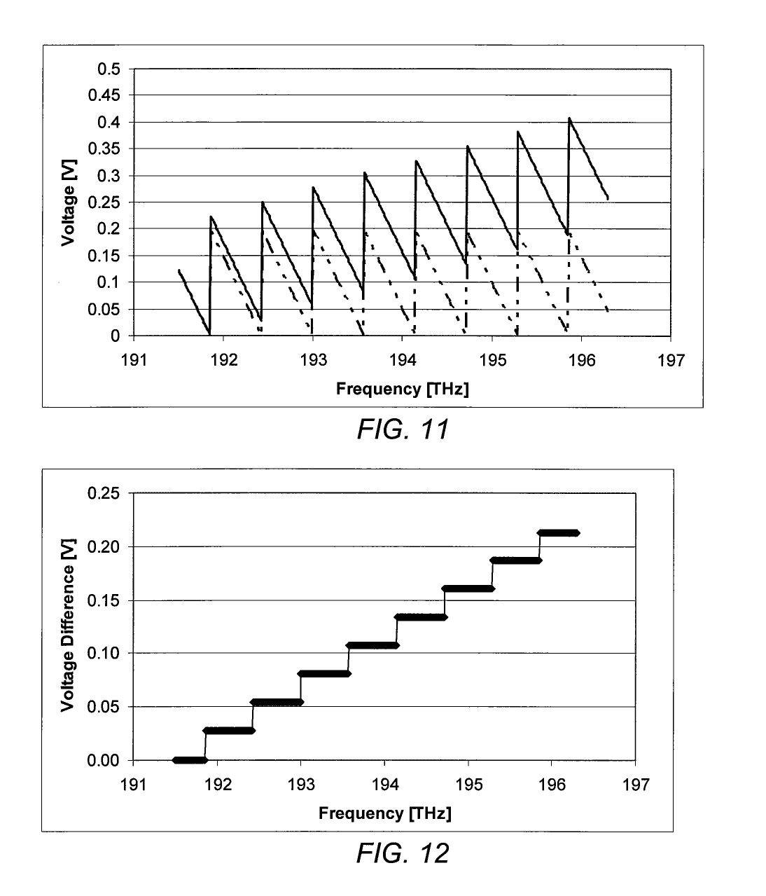

An embodiment wherein a larger number of cycles, in this case 9 cycles (C=9), is used to produce a larger Vernier effect is shown in FIG. 11. The voltage for N1 is shown to the left of the figure and the voltage on N2 is shown to the right of the figure. The data points for N1 are shown as open circles and those for N2 are shown as solid circles. This embodiment corresponds to Example 2 described earlier, where the FSRs of the two etalons, N1 and N2, are smaller than in Example 1.

The voltage difference between N1 and N2 during the cycles is shown in FIG. 12. The voltage difference in this example is 0.027 volts, smaller than in Example 1.

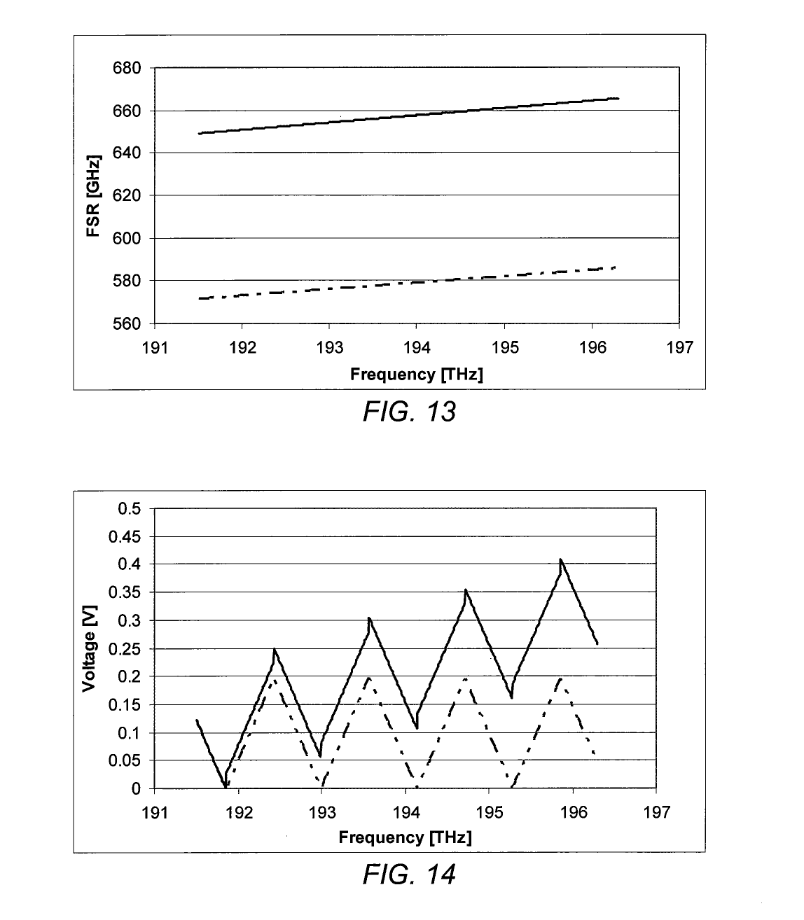

FIG. 13 illustrates the variation in the FSRs of each etalon as a result of the voltage cycling shown in FIGS. 11 and 12. The data for N1 is shown as a dashed line and the data for N2 is shown as a solid line. The FSR range per cycle for each etalon is approximately 0.05 GHz per cycle.

The cycles shown in FIGS. 9 and 11 follow a modified sawtooth pattern. The voltage applied to each LCTE starts from a high value, goes to zero or near zero, then returns in a step to a high value. This type of pattern is sometimes referred to as a return to zero pattern. Using the terminology above, etalon N1 is cycled between V1_{N1} and V2_{N1}. The range for that cycle is ΔV_{N1}. Etalon N2 is cycled between V1_{N2} and V2_{N2}. The range for that cycle is ΔV_{N2}. In the embodiments of FIGS. 9 and 11, V1 for each cycle is larger than V2. In an equally useful cycle pattern, V2 for each cycle is larger than V1.

A more efficient cycle pattern is shown in FIG. 13. Here, the voltages on both LCTEs are cycled in a sawtooth pattern. In the first cycle, V1 is greater than V2; in the second cycle, V2 is greater than V1; and so on.

It should be understood that the specific shape of the pattern is not critical to the operation of the invention. The up and down steps may have any suitable shape. A sinusoidal pattern may be preferred in some cases.

Two modules (N=2) in the device is the minimum for the devices described here. It is anticipated that more demanding applications may require at least three modules.

The voltage of each module should be aligned to match the FSR peak of the associated etalon at the desired tuning frequency. To maintain the filter shapes and the FSR alignment such that the ACR degrades by, for example, less than 1 dB, the tuning voltage is preferably accurate to at least ±0.01 volt. However, the accuracy may vary significantly depending on the application. It should be understood that when voltages are referred to as “equal” or “the same” a reasonable voltage tolerance should be inferred.

The LCTFs in the examples described here are designed for optical transmission systems that typically operate with a wavelength band centered at or near 1.55 microns. The wavelength range desired for many system applications is 1.525 to 1.610 microns. This means that the materials used for the etalons should have a wide transparent window around 1.55 microns. However, LCTF devices are useful for other wavelength regimes as well, such as 1.310 microns.

The structure of the liquid crystal Fabry-Perot etalons is essentially conventional, each comprising a transparent plate with parallel boundaries. A variety of materials may be used, with the choice dependent in part on the signal wavelength, as just indicated, and the required tuning range. Typical cross section dimensions for the etalons are 1.8 mm square, with the optical active area approximately 1.5 mm square. The thickness of the LCTF etalons may be less than 1 mm.

The embodiments described above produce LCTF devices with fine tuning capability. However, industrial applications may be found wherein it is desirable to have a simpler device. To achieve this, according to an alternative embodiment of the invention, one etalon performs only one cycle while the other(s) remains at a fixed voltage.

The etalons in Example 1 have a nominal (room temperature) FSR of 1.81 THz and 2.0 THz respectively, a difference of 190 GHz. For example 2, the etalons have a FSR of 572 GHz and 650 GHz respectively, a difference of 78 GHz. This illustrates that the difference in FSR between etalon modules may be relatively large. For most practical embodiments of the invention the FSR difference will be at least 10 GHz. A difference in the range of 10 to 500 GHz would be typical.

As should be evident, the number of voltage cycles C used to scan a given frequency band may vary widely. The presence of any given number of cycles can be a useful indication of operation of the LCTF according to the invention. Since one aspect of the invention is, for a given frequency scan band, to divide the band into S sub-bands and cycle the voltage of the N etalons for each sub-band, the advantages of this aspect of the invention may be considered realized if the scan is divided into at least three sub-bands and the voltage of the etalons is cycled at least three times (C=3) during the scan. However, more optimum Vernier operation may be realized if the overall scan is divided into a larger number of sub bands.

Other alternative embodiments include the use of multiple cavity etalons. For example, for a LCTF device having N=2, a twin cavity etalon may be used. However the presence of a third inter mirror cavity creates a higher-order modulation on the filter transmittance, and unwanted coupling between the individual FP cavities becomes more severe as the spacing between etalons is reduced. Also, with the etalon cavities separated, one or more fiber-optic isolators may be used to control inter cavity coupling.

Other alternative embodiments may be designed with reflecting surfaces to fold the optical path. Supplemental lens arrangements may be used for steering or focusing the beam as desired. These kinds of device modifications are within the contemplation and scope of the invention.

While the foregoing is directed to embodiments of the present invention, other and further embodiments of the invention may be devised without departing from the basic scope thereof, and the scope thereof is determined by the claims that follow.

We claim:

1. A method for tuning an optical filter having at least two voltage controlled Fabry-Perot liquid crystal etalon modules N1 and N2, wherein the overall filter has a required total free spectral range (FSR) of X, and module N1 has an FSR of X1 which is in the range 0.008X to 0.5X, and module N2 has an FSR of X2 that is less than X1 and in the range 0.008X to 0.5X, the method comprising:
simultaneously changing the voltage of the N1 and N2 modules over a range of V1 to V2.

2. The method of claim 1, wherein the voltages of N1 and N2 are cycled through C cycles, and each cycle comprises:
simultaneously changing the voltage V_{N1} of the N1 module over a range of V1_{N1} to V2_{N1} and changing the voltage V_{N2} of the N₂ module over a range of V1_{N2} to V2_{N2}, where the voltage difference V_{N2}−V_{N1} is fixed during any one cycle and changes from cycle to cycle.

3. The method of claim 2, wherein C is at least 2.

4. The method of claim 2, wherein three or more voltage controlled Fabry-Perot liquid crystal etalon modules are used.

5. The method of claim 1, wherein the voltage change occurs while an optical signal is transmitted through the optical filter.

6. The method of claim 5, wherein the optical signal has a center wavelength near 1.55 microns.

7. The method of claim 1, wherein X2 is approximately 0.9*X1.

8. An optical filter, having a required total free-spectral range (FSR) of X, comprising:
a liquid crystal Fabry-Perot etalon module N1, the module N1 having a Free Spectral Range (FSR) of X1, which is in the range 0.008X to 0.5X;
an N1 voltage control for controlling the voltage of the module N1;
a liquid crystal Fabry-Perot etalon module N2 spaced from and optically aligned with the module N1, the module N2 having a FSR of X2 that is less than X1 and in the range 0.008X to 0.5X; and
an N2 voltage control for controlling the voltage of the module N2.

9. The optical filter of claim 8, wherein the N1 and N2 voltage controls are controlled to simultaneously change the voltage of the N1 and N2 modules over a range of V1 to V2.

10. The optical filter of claim 9, wherein V1 is greater than V2.

11. The optical filter of claim 9, wherein V1 is less than V2.

12. The optical filter of claim 9, wherein V1 is greater than V2 during one cycle, and V1 is less than V2 during another cycle.

13. The optical filter of claim 9 wherein the change in the voltage of the N1 and N2 modules follows a sinusoidal waveform.

14. The optical filter of claim 8 wherein the etalon modules comprise nematic liquid crystals.

15. An optical filter having a plurality of liquid crystal etalon modules connected in a cascaded manner, wherein a Free Spectral Range (FSR) of the optical filter is X and the FSR of each of the etalon modules is equal to or less than 0.5*X.

16. The optical filter of claim 15, wherein at least three liquid crystal etalon modules are connected in a cascaded manner and the FSR of each of the etalon modules is equal to or less than 0.33*X.

17. The optical filter of claim 15, wherein each of the etalon modules include a voltage control unit to enable a Vernier tuning control of the optical filter.

18. The optical filter of claim 17, wherein the voltage control units are controlled to simultaneously change the voltage of the etalon modules over a range of V1 to V2.

19. The optical filter of claim 18, wherein the FSRs of at least two of the etalon modules differ by 5% to 40%.

20. The optical filter of claim 15, wherein the liquid crystal etalon modules comprise Fabry-Perot etalon modules having nematic liquid crystals.
